(19) United States
(12) Patent Application Publication
(10) Pub. No.: US 2012/0295118 A1
(43) Pub. Date: Nov. 22, 2012

(54) ANTIBACTERIAL TOUCH PANEL AND PRODUCTION PROCESS THEREOF

(75) Inventor: Yu-Hui Huang, Yangmei Town (TW)

(73) Assignee: PROSPER PEAK LIMITED

(21) Appl. No.: 13/108,966

(22) Filed: May 16, 2011

(51) Int. Cl. B32B 9/00; B05D 3/06; B82Y 30/00

(52) U.S. Cl. 428/446; 427/559; 427/558; 977/700

(57) ABSTRACT

The present invention relates to an antibacterial touch panel and the production process thereof. The said antibacterial touch panel comprises an anti-fog and antibacterial layer and a substrate of the touch panel. The said anti-fog and antibacterial layer is applied to the surface of the substrate of the touch panel and photocatalytically reacts with ultraviolet light or any visible light. Finally, an antibacterial touch panel with the anti-fog and antibacterial properties is formed.

### FIELD OF THE INVENTION

The present invention relates to an antibacterial touch panel and the production process thereof, in particular to an antibacterial touch panel, wherein reactions are photocatalytically driven on the panel to form an anti-fog and antibacterial touch panel, as well as to the production process thereof.

### BACKGROUND OF THE INVENTION

The users of conventional touch panels may convert the area of the panel that comes into contact with a finger or a touch pen into an electrical signal. The signal is then computerized. Such an operation is quite convenient and accessible for users. Owing to their convenience and practicality, the commercially available touch panels are extensively used for various sizes or fields; for example, panels of small size, such as diverse portable electronic products, including personal digital assistant (PDA), palm-sized PC, mobile phone, handwriting input device and information appliance, and those of large size, such as automated teller machine (ATM), point of sale (POS) or industrial computer used as terminal.

For the antibacterial design of the currently existing touch panels, it is necessary to apply nanometer-sized inorganic metal materials or organic hexylamine salts on the substrate of the touch panel to achieve a long-term antibacterial efficacy. However, because the nanometer-sized inorganic metal materials possess biochemical activities that are possibly completely exhausted, it is therefore necessary to repeatedly apply the coating material to the substrate. The released antibacterial substances are adsorbed on the objects contacted and they may be toxic to human body or environment and cause environmental pollution. The organic hexylamine salts only act as catalyst for the destruction of the charge balance of the cell. Although the concentration of the antibacterial agent may be maintained, it is possible that the antibacterial agent is detached or lost from the touch panel due to insufficient covalent bonding with the surface of the substrate during its use and the weakening of the antibacterial effect then appears

Furthermore, either the nanometer-sized inorganic metal materials or the organic hexylamine salts used in the anti-fog and antibacterial layer of the existing touch panels do not have the hydrophilic and anti-fog functions, and also do not elevate the productivity and reduce the production cost.

### SUMMARY OF THE INVENTION

The primary object of the invention is to provide an antibacterial touch panel, wherein an anti-fog and antibacterial layer is formed on the substrate of the touch panel.

The secondary object of the invention is to provide a process of forming an anti-fog and antibacterial layer on the substrate of the touch panel.

To achieve these objects, the present invention provides an antibacterial touch panel that comprises a substrate of the touch panel and an anti-fog and antibacterial layer,

wherein the said anti-fog and antibacterial layer is applied to the surface of the substrate of the aforementioned touch panel and consists of nanometer-sized materials of the following formula:

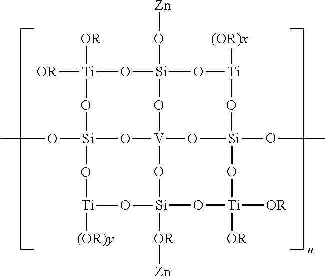

wherein R is selected from the group that consists of halogen, hydrogen, alkyl, alkoxy, hydroxyl, alkenyl, alkynyl, acyl, aryl, carboxyl, alkoxycarbonyl and aryloxycarbonyl; x and y are integrals between 0 and 2, respectively; n stands for an integral between 1 and 1000.

To achieve the aforementioned objects, the present invention provides a process of producing an antibacterial touch panel, that comprises the following steps:

(i) a nanometer-sized material of vanadium-doped titanium dioxide (V—TiO₂) and zinc oxide (ZnO) as well as a substrate of the touch panel are provided; the aforementioned nanometer-sized material of vanadium-doped titanium dioxide and zinc oxide is applied to the surface of the substrate of the foregoing touch panel and accordingly allowed to be attached to the substrate of the touch panel;
(ii) a light-irradiated nanometer-sized material of vanadium-doped titanium dioxide and zinc oxide, that is applied to the aforementioned touch panel, is provided and the material is then allowed to react with the light to form an anti-fog and antibacterial layer on the surface of the substrate of the touch panel.

With the aid of the aforementioned antibacterial touch panel and production process thereof, an anti-fog and antibacterial layer is formed on one surface of the substrate of the touch panel. This may not only achieve a long-term antibacterial efficacy, but also elevate the productivity and reduce the production cost because the anti-fog and antibacterial layer according to the invention reacts in a photocatalytic manner.

### BRIEF DESCRIPTION OF THE DRAWINGS

FIG. 1 shows a section view of the antibacterial touch panel according to the invention.

FIG. 2 shows the procedure of the first embodiment in the process of producing an antibacterial touch panel according to the invention.

FIG. 3 shows the procedure of the second embodiment in the process of producing an antibacterial touch panel according to the invention.

### DETAILED DESCRIPTION OF THE PREFERRED EMBODIMENTS

The aforementioned objects of the present invention and the structural and functional properties thereof shall be explained according to the preferred embodiments of the attached figures.

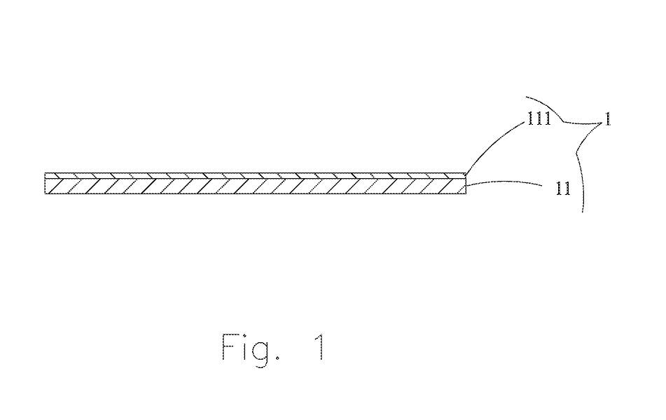

FIG. 1 shows a section view of the antibacterial touch panel according to the invention. As shown in FIG. 1, the said antibacterial touch panel 1 comprises a substrate of the touch panel 11 and an anti-fog and antibacterial layer 111;

The said anti-fog and antibacterial layer 111 is applied to the surface of the substrate of the aforementioned touch panel 11 and consists of nanometer-sized materials of the following formula:

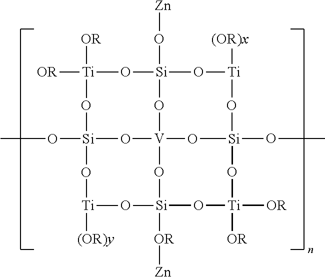

wherein R is selected from the group that consists of halogen, hydrogen, alkyl, alkoxy, hydroxyl, alkenyl, alkynyl, acyl, aryl, carboxyl, alkoxycarbonyl and aryloxycarbonyl; x and y are integrals between 0 and 2, respectively; n stands for an integral between 1 and 1000. Furthermore, R can be selected from the group that consists of —H, —OH, —OCH₃, —OC₂H₅, —CH₃, —CH═CH₂, —OC₂H₄OCH₃ or —C₃H₆COOC₂H₅.

The aforementioned nanometer-sized material for the anti-fog and antibacterial layer uses vanadium-doped titanium dioxide and zinc oxide to absorb ultraviolet light or any visible light. The light absorbed by the material excites a number of electrons from its valence band to the conduction band to generate a hole-electron pair. This is called photocatalytic reaction.

Electrons have reducing capacity. An electron hole also has oxidizing capacity. A hole-electron pair can adsorb surface oxygen or water molecules to undergo an oxidoreductive reaction and generate highly active free radicals (such as O₃). The active oxide ions (O₂⁻) have an oxidative effect and an oxidizing capacity and penetrate into a bacterium or a virus to denature bacterial or viral proteins such that the bacterial or viral enzyme systems are crippled and the bactericidal effect is thus achieved. The antibacterial mechanism is associated with the use of the high reduction potential of the oxides with high valence state to generate atomic oxygen in its surrounding. Therefore, it is harmless to the environment and the human body.

In addition, silicone dioxide (SiO₂) in the nanometer-sized material of the aforementioned formula utilizes the incomplete coordination of surface atoms to increase the surface-activated positions in order that the generated catalytic capacity has reducing capacity (such as O₃) and triggers the oxygen atom of the water molecule and the oxygen molecule in the air to form a hydroxyl group and an active oxide ion. The active oxide ions have an oxidative effect and an oxidizing capacity and can rapidly diffuse and penetrate into a bacterium in a short time and their oxidative effect denatures the bacterial proteins so that the bacterial enzyme systems are destroyed and the antibacterial effect is thus achieved. The antibacterial effect is associated with the valence state per se. The oxides with high valence state have a high reduction potential that allows their surrounding space to generate atomic oxygen and thus have an antibacterial effect.

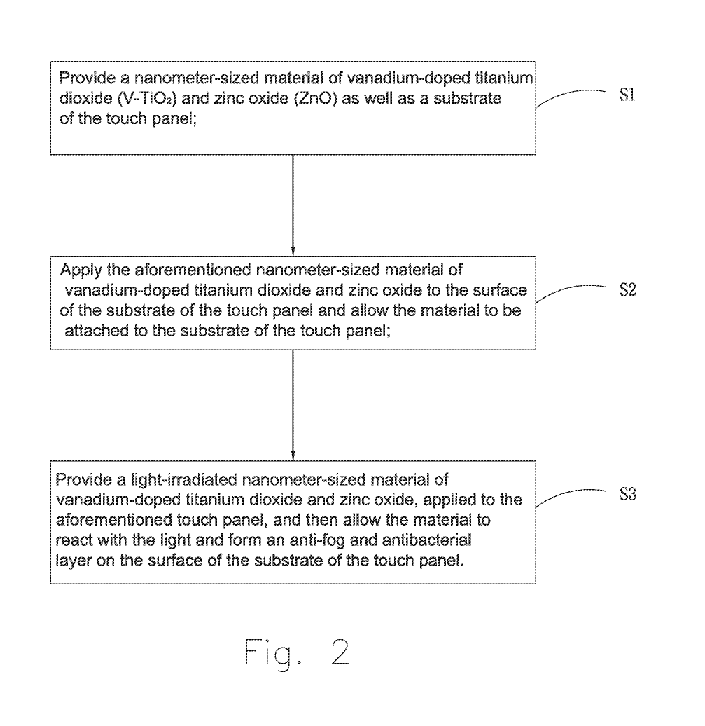

FIG. 2 shows the procedure of the first embodiment in the process of producing an antibacterial touch panel according to the invention. In combination with FIG. 1, the said process of producing an antibacterial touch panel comprises the following steps:

step 1: a nanometer-sized material of vanadium-doped titanium dioxide and zinc oxide as well as a substrate of the touch panel are provided;
a nanometer-sized material of vanadium-doped titanium dioxide and zinc oxide as well as a substrate of the touch panel 11 are provided.
step 2: the aforementioned nanometer-sized material of vanadium-doped titanium dioxide and zinc oxide is applied to the surface of the substrate of the touch panel and subsequently allowed to be attached to the substrate of the touch panel;
the aforementioned nanometer-sized material of vanadium-doped titanium dioxide and zinc oxide is applied to the surface of the substrate 11 of the foregoing touch panel and subsequently allowed to be attached to the substrate 11 of the touch panel.
step 3: a light-irradiated nanometer-sized material of vanadium-doped titanium dioxide and zinc oxide, that is applied to the touch panel, is provided and the material is then allowed to react with the light to form an anti-fog and antibacterial layer 111 on the surface of the substrate 11 of the touch panel.
A ultraviolet light- or any visible light-irradiated nanometer-sized material of vanadium-doped titanium dioxide and zinc oxide, that is applied to the touch panel, is provided. The said material is then allowed to react with the light and absorbs the light. The said material is then allowed to undergo a photocatalytic reaction and subsequently to form an anti-fog and antibacterial layer 111 on the surface of the substrate 11 of the touch panel.

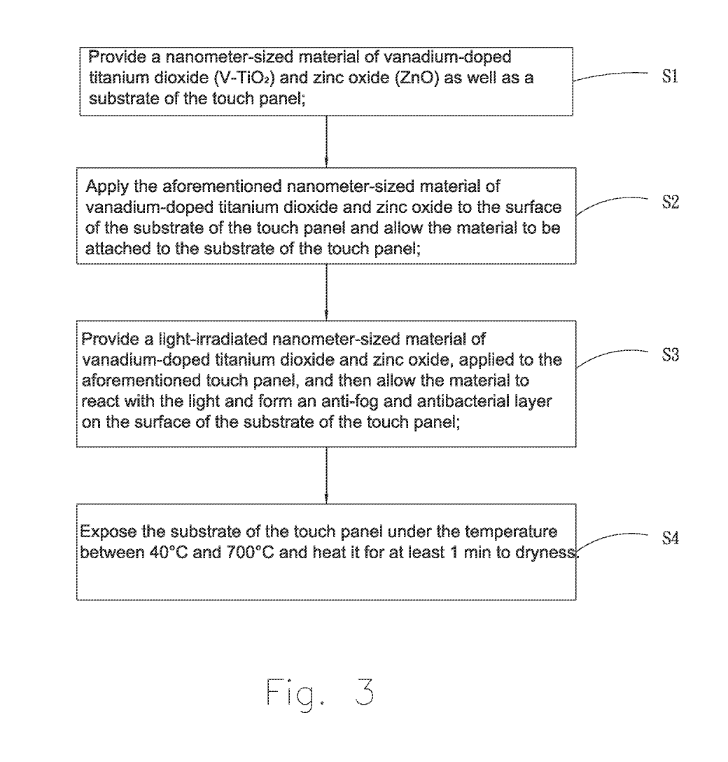

FIG. 3 shows the procedure of the second embodiment in the process of producing an antibacterial touch panel according to the invention. The said process of producing an antibacterial touch panel comprises the following steps:

step 1: a nanometer-sized material of vanadium-doped titanium dioxide and zinc oxide as well as a substrate of the touch panel are provided;
step 2: the aforementioned nanometer-sized material of vanadium-doped titanium dioxide and zinc oxide is applied to the surface of the substrate of the touch panel and subsequently allowed to be attached to the substrate of the touch panel;
step 3: a light-irradiated nanometer-sized material of vanadium-doped titanium dioxide and zinc oxide, that is applied to the touch panel, is provided and the material is then allowed to react with the light to form an anti-fog and antibacterial layer on the surface of the substrate of the touch panel.

The second embodiment has a part of the procedure that is identical to that of the first embodiment mentioned above and hence shall not be described any more. The difference between the second embodiment and the first embodiment mentioned above lies in the said step 3: a light-irradiated nanometer-sized material of vanadium-doped titanium dioxide and zinc oxide, that is applied to the touch panel, is provided and the material is then allowed to react with the light to form an anti-fog and antibacterial layer on the surface of the substrate of the touch panel. After this step, there is an additional step 4: the substrate of the touch panel is exposed under the temperature between 40° C. and 700° C. and heated for at least 1 min to dryness.

Step 4: the substrate of the touch panel is exposed under the temperature between 40° C. and 700° C. and heated for at least 1 min to dryness.

The substrate 11 of the touch panel is exposed under the temperature between 40° C. and 700° C. and heated for at least 1 min to dryness. Finally, the substrate 11 of the touch panel, applied with the nanometer-sized material of vanadium-doped titanium dioxide and zinc oxide, is exposed at room temperature for at least 12 hours and then the antibacterial touch panel is formed.

The contact angle of the surface hydrophilicity of the said anti-fog and antibacterial layer 111 is approximately 72°. After light irradiation, the contact angle of the hydrophilicity is <5° and ≧0°. A water drop can completely impregnate the surface. This shows its hydrophilic and anti-fog properties. Furthermore, it can decompose greasy dirt and dust simultaneously. The decomposed dirt can be removed easily.

Taken together, the antibacterial touch panel 1 according to the invention utilizes the nanometer-sized material of vanadium-doped titanium dioxide and zinc oxide as anti-fog and antibacterial material. The material absorbs ultraviolet light or any visible light to excite a number of electrons from its valence band to the conduction band and generate a hole-electron pair. The hole-electron pair then adsorbs surface oxygen molecules or water molecules to undergo an oxido-reductive reaction and thus achieve the antibacterial effect. After ultraviolet light irradiation, the contact angle of the hydrophilicity can reach up to 0°. This result shows its hydrophilic and anti-fog properties and can enhance its hydrophilic and anti-fog performance. At the same time, its productivity and simplified design in a one-time operating manner can help to elevate the productivity and reduce the production cost.

The invention has been specified in the text above. However, the description above serves only as one preferable embodiment and can not limit the scope of the invention. Every amendment and modification according to the claims of the invention should be within the scope of the invention.

What is claimed is:

1. An antibacterial touch panel, comprising:
a substrate of the touch panel; and
an anti-fog and antibacterial layer that is applied to the surface of the substrate of the touch panel and that consists of nanometer-sized materials of the following formula: 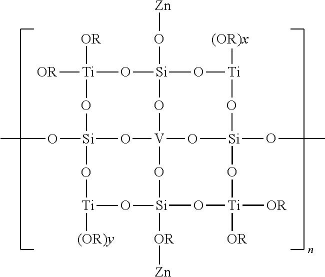
wherein R is selected from the group that consists of halogen, hydrogen, alkyl, alkoxy, hydroxyl, alkenyl, alkynyl, acyl, aryl, carboxyl, alkoxycarbonyl and aryloxycarbonyl; x and y are integrals between 0 and 2, respectively; n stands for an integral between 1 and 1000.

2. An antibacterial touch panel according to claim 1, wherein R can be selected from the group that consists of —H, —OH, —OCH₃, —OC₂H₅, —CH₃, —CH═CH₂, —OC₂H₄OCH₃ or —C₃H₆COOC₂H₅.

3. A process of producing an antibacterial touch panel, comprising the following steps:
(i): a nanometer-sized material of vanadium-doped titanium dioxide and zinc oxide as well as a substrate of the touch panel are provided;
(ii): the aforementioned nanometer-sized material of vanadium-doped titanium dioxide and zinc oxide is applied to the surface of the substrate of the touch panel and subsequently allowed to be attached to the substrate of the touch panel;
(iii): a light-irradiated nanometer-sized material of vanadium-doped titanium dioxide and zinc oxide, that is applied to the touch panel, is provided and the material is then allowed to react with the light to form an anti-fog and antibacterial layer on the surface of the substrate of the touch panel.

4. A process of producing an antibacterial touch panel according to claim 3, wherein the said light is ultraviolet light or any visible light, with which the substrate of the touch panel, that is applied with the nanometer-sized material of vanadium-doped titanium dioxide and zinc oxide, is irradiated and the nanometer-sized material of vanadium-doped titanium dioxide and zinc oxide absorbs the said light and this allows the material to undergo a photocatalytic reaction.

5. A process of producing an antibacterial touch panel according to claim 3, wherein there is an additional step, in which the substrate of the touch panel is exposed under the temperature between 40° C. and 700° C. and heated for at least 1 min to dryness.

6. A process of producing an antibacterial touch panel according to claim 3, wherein there is an additional step, in which the substrate of the touch panel, applied with the nanometer-sized material of vanadium-doped titanium dioxide and zinc oxide, is exposed at room temperature for at least 12 hours.

7. A process of producing an antibacterial touch panel according to claim 3, wherein the contact angle of the surface hydrophilicity of the anti-fog and antibacterial layer is approximately 72°.

8. A process of producing an antibacterial touch panel according to claim 3, wherein the contact angle of the surface hydrophilicity of the anti-fog and antibacterial layer is <5° and ≧0°.
